(19) United States
(12) Patent Application Publication
(10) Pub. No.: US 2009/0002178 A1
(43) Pub. Date: Jan. 1, 2009

(54) DYNAMIC MOOD SENSING

(75) Inventors: Shai Guday, Redmond, WA (US); Bret P. O'Rourke, Kirkland, WA (US); Eric Peter Wilfrid, Mountain View, CA (US); Zachary L. Russell, Bellevue, WA (US); Boyd C. Multerer, Redmond, WA (US); Andrew David Wilson, Seattle, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/771,461

(22) Filed: Jun. 29, 2007

(51) Int. Cl. G08B 23/00

(52) U.S. Cl. 340/573.1

(57) ABSTRACT

A system that facilitates personalized sensing is provided. The system includes a sensing component that determines one or more user states based in part on a detected context and a mood component that employs the detected user states to indicate a dynamic condition of a user.

### BACKGROUND

Present human interface systems come in many forms. There is the common graphical user interface used on desk top computers and various other forms such as button controls and menus commonly employed by mobile devices such as cell phones. Most interface systems operate in a somewhat static environment and generally provide static choices as to how humans may interact with the respective systems. For example, when operating a cell phone, a static menu list is provided to the user that allows adjusting the various features of the phone such as sounds, numbers, functionality, and so forth. In a desktop computer application, depending on the application that is selected, a standard set of interfaces and static grouping of interface options are provided. These interfaces often don't account for the particular nuances of a user on a given day. For instance, the interface would change whether the user was in a relatively good mood or some other mood.

Graphical user interface design is an important component to application programming and ultimately user experience. Its goal is to enhance the usability of the underlying logical design of a stored program. The visible graphical interface features of an application are sometimes referred to as “chrome.” They include graphical elements that may be used to interact with the program. Common elements are: windows, buttons, menus, and scroll bars, for example. Larger interfaces, such as windows, usually provide a frame or container for the main presentation content such as a web page, email message or drawing. Smaller ones usually act as a user-input tool. Interface elements or items of a well-designed system are functionally independent from and indirectly linked to program functionality, so the graphical user interface can be easily customized, allowing the user to select or design a different skin at will. Even though customization is possible, these interfaces do not dynamically or automatically adjust themselves to the present state associated with the user.

In another type of interface, many research groups in North America and Europe are currently working on the Zooming User Interface (ZUI) which is a logical advancement on the graphical user interface, blending some three-dimensional movement with two-dimensional or “2.5D” vector objects.

Some graphical user interfaces are designed for the rigorous requirements of vertical markets. These are known as “application specific graphical user interfaces.” Examples of application specific graphical user interfaces include: Touch-screen point of sale software used by wait staff in busy restaurants; Self-service checkouts used in some retail stores; Automatic teller machines; Airline self-ticketing and check-in; Information kiosks in public spaces like train stations and museums; and Monitor/control screens in embedded industrial applications which employ a real time operating system (RTOS). The latest cell phones and handheld game systems also employ application specific touch-screen graphical user interfaces.

Graphical user interfaces were introduced in reaction to the steep learning curve of command line interfaces (CLI), which require commands to be typed on the keyboard. Since the commands available in command line interfaces can be numerous, complicated operations can be completed using a short sequence of words and symbols. This allows for greater efficiency and productivity once many commands are learned, but reaching this level takes some time because the command words are not easily discoverable. Most modern operating systems provide both a graphical user interface and some level of CLI although the graphical user interfaces usually receive more attention.

Many times people have underlying feelings that are not necessarily articulated but provide an alternative communications means yet are not plugged into current interface schemes. Even though not articulated, emotions or moods often affect how one interacts with others on a given day. Rather than having to be explicit about things, people are often misunderstood as to their true intentions since these underlying emotions may not be sensed as one would desire. Additionally, machines that humans interact with likely operate more harmoniously with them if somehow these alternative forms of communication could be understood in some manner and subsequently exploited.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

Mood sensing components and systems are provided that allows emotions and other feelings to be dynamically detected and later employed as a form of communications to other humans or machines. User contexts can be sensed such as how fast they are working, how easily they are distracted, how their voices have raised, the type of words that are chosen and so forth, where a sensing component determines a mood or range of emotions based on the determined context. A mood component can be employed to drive one or more controls such as dynamically controlled mood ring that provides an indication of one's emotions at a given time. More sophisticated controls can employ the moods detected to alter user interfaces, adjust output controls to softer or louder depending on mood, control different music selections, change backgrounds, or provide coaching tips to cause a change in moods. Biometric sensors can also be employed to determine a given mood.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating a mood sensing and interface system.

FIG. 2 is a block diagram that illustrates a mood interface system.

FIG. 3 illustrates exemplary mood sensing input components for controlling mood-driven applications.

FIG. 4 illustrates example mood applications.

FIG. 5 illustrates an example mood schema.

FIG. 6 illustrates healthcare applications that can be facilitated by mood detection.

FIG. 7 illustrates a system that employs an adaptable mood interface to control various applications.

FIG. 8 illustrates an exemplary process for analyzing mood data to automatically control one or more applications.

FIG. 9 is a schematic block diagram illustrating a suitable operating environment.

FIG. 10 is a schematic block diagram of a sample-computing environment.

### DETAILED DESCRIPTION

Systems and methods are provided for dynamically sensing moods and emotions and subsequently adjusting controls. In one aspect, a system that facilitates personalized sensing is provided. The system includes a sensing component that determines one or more user states based in part on a detected context and a mood component that employs the detected user states to indicate a dynamic condition of a user.

As used in this application, the terms “component,” “sensor,” “control,” “database,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

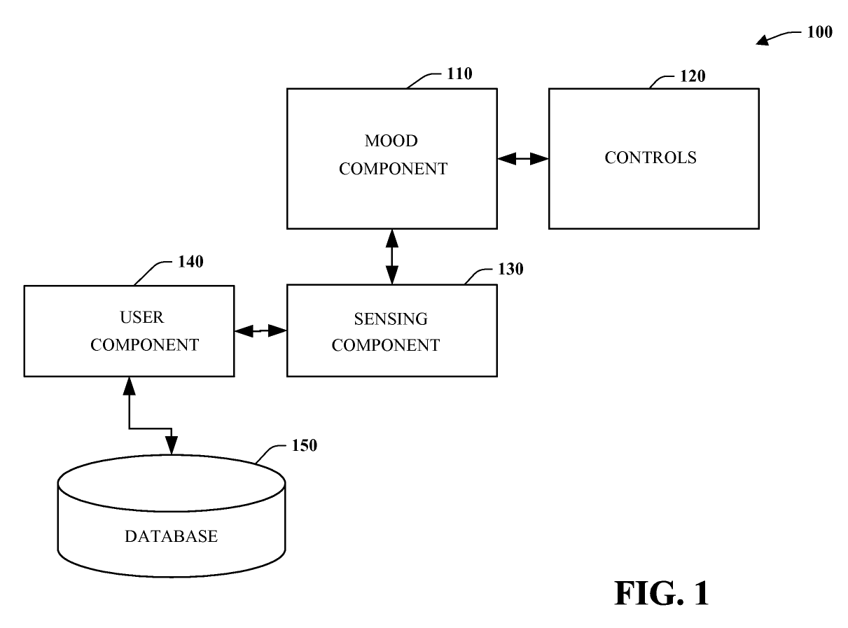

Referring initially to FIG. 1, a system 100 is illustrated for dynamic mood sensing. The system 100 includes a user component 110 that processes data from a data store 120. Such data can be gleaned and analyzed from a single source or across multiple data sources, where such sources can be local or remote data stores or databases. The user component 1 10 can be files or data structures that maintain states about the user and can be employed to determine future states. These can be past action files for instance that store what a user has done in the past and can be used by intelligent components such as classifiers to predict future actions. A sensing component 130 is associated with a user (or group of users) and is employed to detect some biological aspect of the user. This can be biometric devices, temperature sensors, electronic sensors, perspiration detectors, facial recognizers, acoustic sensors, or applications that monitor user activities such as a key stroke monitor on a key board.

Upon sensing one or more biological aspects from the user, a mood component 140 is employed to detect a present state of the user in view of the feedback received from the sensing component 130. For example, if rapid eye twitches were detected along with a raised voice, the mood component 140 may determine the user is agitated. Based on the detected mood at 130, one or more controls 150 can be dynamically adjusted in view of the detected mood. For instance, the controls 120 may be associated with some type of user interface that is adjusted based on a detected or present mood.

The system 100 can be employed as a mood sensing system that allows emotions and other feelings to be dynamically detected at 140 and later employed as a form of communications to other humans or machines via the controls 120. User contexts can be sensed such as how fast they are working, how easily they are distracted, how their voices have raised, the type of words that are chosen and so forth, where the sensing component 130 and the mood component 140 determines a mood or range of emotions based on the determined context. The mood component 140 can be employed to drive one or more controls 120 such as dynamically controlled mood ring that provides an indication of one's emotions at a given time. More sophisticated controls 120 can employ the moods detected to alter user interfaces, adjust output controls to softer or louder depending on mood, control different music selections, change backgrounds, change lighting, change music selections, or provide coaching tips to cause a change in moods.

Related aspects can be annotating or processing mood metadata that could be attached to e-mails or memoranda for example. Mood data can be employed to facilitate interpersonal sharing, trusted modes, and context sharing for example. Mood data which can be stored at 120 can also be employed to control virtual media presentations and control community interactions such as the type of interface or avatar that may be displayed for a respective user on a given day. Interactive data can be generated in view of the mood data and can be employed to help such problems as attention deficits and other ailments. Special needs people can more effectively communicate when there emotions are also considered along with their explicit communications. Parental controls 120 can be employed with mood data to facilitate rearing of children. Other aspects include adaptive components that can be adjusted on detected emotions, learning problems that are assisted by mood generated data, and monitoring a loved one who for one reason or another is incapable of communicating as in the past. This can include game monitoring and possibly detecting health issues such as Alzheimer's disease based on monitoring game responses over time. Games can also have their options or outcomes changed based on detected emotions along with having environmental changes affected by the respective emotions. In another aspect, an adaptable interface system is provided. The system includes means for detecting one or more mood states of a user or group (sensing component 130) and means for analyzing the mood states of the user or group (mood component 110). This can also include means for controlling the mood states (controls 120) with respect to a selected application.

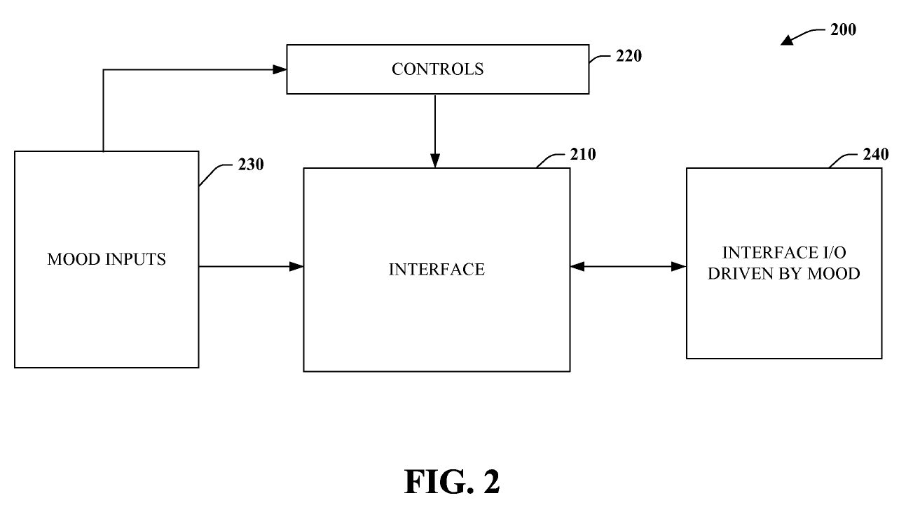

Referring now to FIG. 2, a mood interface system 200 is illustrated. The system 200 includes a mood interface 210 that is responsive to one or more controls 220 and one or more mood inputs 230. The mood inputs 230 can be received from a plurality of sources and are described in more detail below. In general, the controls 220 and mood inputs 230 are processed to determine what type of mood interface 210 to present to the user. As shown, interface inputs and/or outputs (I/O) 240 can be adjusted and controlled by the interface 210. For example, the mood inputs 230 can be processed to determine that the user is in a mellow mood where the interface 210 can be adjusted to reflect such mood. If light pastel colors were determined to coincide with a mellow mood, such colors could be employed at the interface I/O 240. In this example, background screens could be changed to reflect the mellow mood, application logos altered, sounds adjusted, mobile devices such as a mood ring or watch could change to reflect the mood via the interface I/O 240.

If the I/O 240 were associated with a ring, wireless signals could alter colors or other output such as sound emanating from the ring. If the I/O 240 were a desktop computer, substantially any application interface can be altered in view of the detected mood from the mood inputs 230. The controls 220 can be used to determine how mood changes are implemented with respect to a given device or application. For example, a schema described below provides user settings and conditions for when mood adjustments are to be employed. Some users may not want mood adjustments to occur at work, for example. Others may desire mood adjustments in some applications yet not desire adjustments enabled for other applications. The interface 210 and I/O 240 can be associated with substantially any type of device including desk top computers, personal digital assistants, telephones, televisions, DVD players, cell phones, jewelry, automobile controls/displays, and so forth.

Before proceeding, it is noted that the interface 210 can be updated from a remote server or on a respective mobile/stationary device itself. This can include a Graphical User Interface (GUI) to interact with the user or other components such as any type of application that sends, retrieves, processes, and/or manipulates data, receives, displays, formats, and/or communicates data, and/or facilitates operation of the system. For example, such interfaces 210 can also be associated with an engine, server, client, editor tool or web browser although other type applications can be utilized.

The GUI can include a display having one or more display objects (not shown) for manipulating the I/O 240 including such aspects as configurable icons, buttons, sliders, input boxes, selection options, menus, tabs and so forth having multiple configurable dimensions, shapes, colors, text, data and sounds to facilitate operations with the profile and/or the device. In addition, the GUI can also include a plurality of other inputs or controls for adjusting, manipulating, and configuring one or more aspects. This can include receiving user commands from a mouse, keyboard, speech input, web site, remote web service and/or other device such as a camera or video input to affect or modify operations of the GUI. For example, in addition to providing drag and drop operations, speech or facial recognition technologies can be employed to control when or how data is presented to the user. The I/O 240 can be updated and stored in substantially any format although formats such as XML may be employed to capture user controls and instructions.

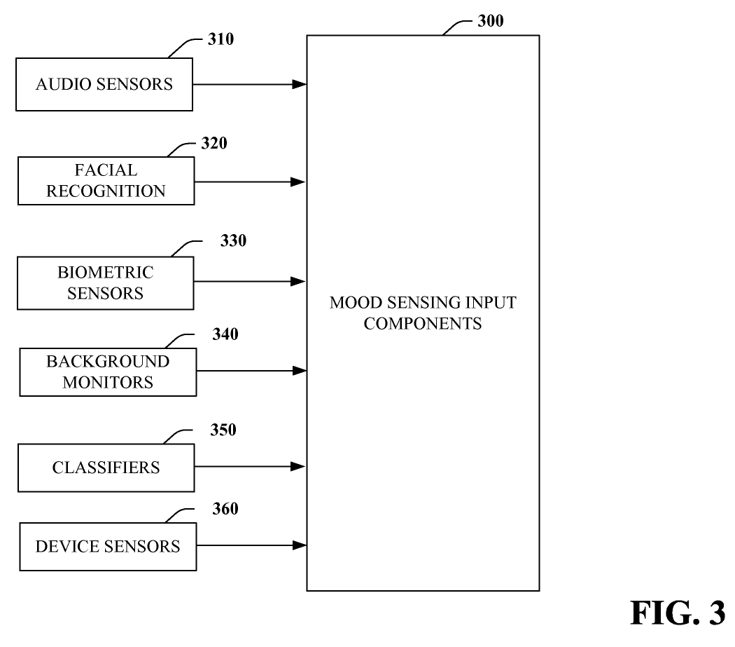

Turning to FIG. 3, exemplary mood sensing input components 300 are illustrated for controlling mood-driven applications. The mood sensing input components 300 can be processed in a background or foreground thread of a computer or micro system. This can include monitoring one or more sensors as individual inputs or collectively analyzing a group of inputs to make a determination about a given user's mood. It should be noted that the mood sensing input components 300 can be applied to individuals or groups. For example, if acoustics were monitored for a group and the lighting of a room were adjusted for the mood of the group (e.g., laughter detected brighten the lighting, hushed tones dim the lighting, etc.). Also, centralized systems can receive mood inputs from a plurality of users over wireless links to adjust mood conditions or interfaces for groups.

In one aspect, one or more audio sensors 310 can be employed to detect mood conditions. This can include microphones associated with substantially any type of device such as a cell phone or a computer. Other types of audio sensing could include vibration or harmonic sensing such as when a group of individuals dance in unison to produce a sound. In another example, musical instrument pickups can be monitored where mood data can be gathered (e.g., slower, quieter guitar song reflecting different mood from a harder rock song.

In another aspect, facial recognition components 320 can be employed. This can include analyzing facial expressions from mobile and/or desktop devices. For instance, a person working at their desk and talking on their cell phone may provide video and/or acoustical mood data for a mood sensing application that is described in more detail below. Facial recognition components are computer-driven applications for automatically identifying or verifying a person from a digital still or video image. It does that by comparing selected facial features in the live image and a facial database. Such features as a smile can be used to determine happiness whereas a detected frown can be utilized to detect sadness for example. Facial recognition data can be compared to other biometrics such as fingerprint or eye iris recognition systems, for example. Popular recognition algorithms include eigenface, fisherface, the Hidden Markov model, and neuronal motivated dynamic link matching. Three-dimensional face recognition technologies can also be employed.

One or more biometric sensors 330 can be employed for mood sensing components 300. A biometric system is essentially a pattern recognition system which recognizes a user by determining the authenticity of a specific physiological or behavioral characteristic possessed by the user. In regard to mood, mood algorithms receive data from such sensors 330 or systems and determine a given mood from the detected input. Generally, a user's biometric patterns are stored in the system so that a biometric template can be captured. This template is securely stored in a central database or a smart card issued to the user. The template can be retrieved when monitoring various physical and bodily conditions. The biometric sensors can take on many forms such as heart rate monitors, retinal scans, perspiration sensors, breathing detectors, and so forth. Substantially any device that can monitor human physical feedback can be employed to determine a potential mood.

In yet another aspect, one or more background monitors 340 can be employed. This can include monitoring how a user interacts with a computer or mobile device. For instance, the speed at which key strokes are entered or telephone numbers entered can be employed to detect a mood. Background monitors 340 can monitor how users interact with various applications. For example, during a normal operating mood, a user may operate interface inputs at a given rate or within a threshold of a given rate. When the user is not feeling as well and the rate of interaction with a given application drops below a threshold, another type of mood can be detected. As can be appreciated, various types of mood sensing components may be analyzed before a given mood is detected.

One or more classifiers 350 may be employed to detect moods over time. The classifiers 350 (or learning components) can monitor inputs or application background conditions over time to detect possible moods. The user can assist the classifiers in training. For example, while the user is working on a text document, they can indicate to a controls interface they are presently in a good mood. During that time, the classifiers can capture nuances of activity during the time of good mood. When other moods are present, the user can update the controls to indicate the change in moods whereby the classifiers can then capture nuances associated with a different mood. When those patterns are detected in the future, mood interfaces can be updated in accordance with the detected mood.

In yet another example, one or more device sensors 360 can be employed. Such sensors can include accelerometers or vibration sensors, for example, that are employed to sense user physical conditions. For example, a slow walk detected may indicate a mellow mood were rapid vibrations detected may indicate an agitated mood. As noted above, more than one input may be processed before a final determination is made about a specific mood. Also, thresholds or ranges can be set before a mood change decision is made. In a simple example, Y heart beats per minute may be set for a normal mood, where X heartbeats above Y is an agitated mood and Z heartbeats below Y is considered a somber mood, X, Y, Z being integers respectively. As can be appreciated, substantially any type of algorithm weighting can be given to any detected input to determine a given mood. Such weightings can also be manually or automatically adjusted over time as mood conditions are refined.

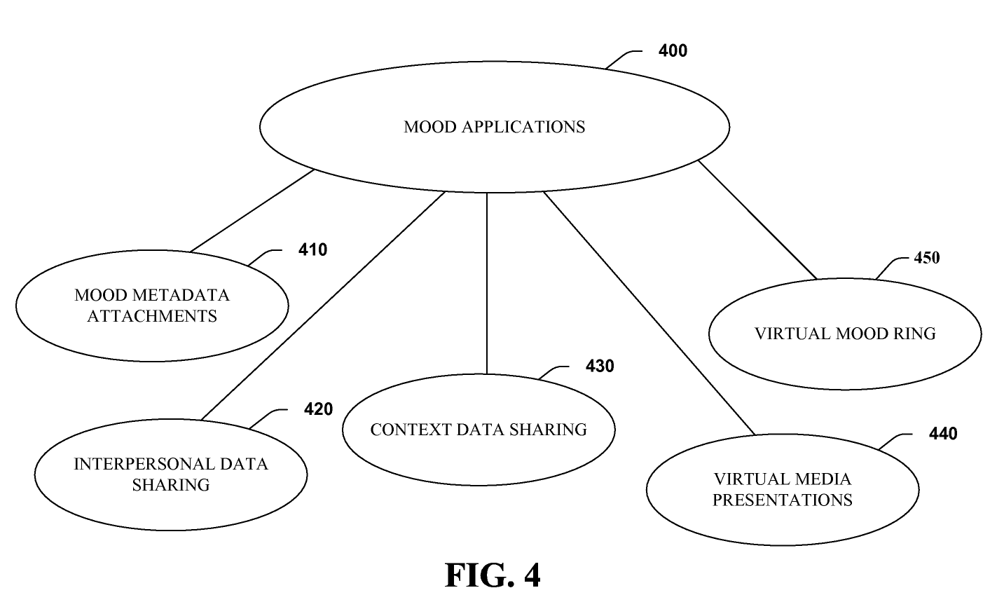

Referring to FIG. 4, example mood applications 400 are illustrated. One type of mood application includes providing mood metadata attachments 410 to an application. For example, mood metadata 410 could be attached to e-mails, voicemails, memoranda, or electronic files, for example. Thus, in a more sophisticated nuance, if a user were in a good mood when they called home a cheery type ring or announcement could accompany the call. If the user were in some other mode, metadata could indicate that some other type of ring or announcement be employed with the respective call. As noted above, mood data can be employed to facilitate interpersonal sharing of data or files at 420. This can include trusted modes and interfaces that are invoked and shared based on the senders detected mood at the time of creating or transferring a file for example. Thus if one created a document in one type of mood, the background of the document, font, or other data associated with the document could be altered to reflect a given mood or state of mind.

In another mood application 400, context data sharing 430 can include altering data or affixing data to indicate or show a mood nuance of a user or group who has created the data. For example, if great synergy were detected within a group based upon detected voice analysis, a mood context could be generating showing a picture of the mood or changing some item of data to indicate the context for the mood such as automatically generating a summary to capture group context. Mood data can also be employed to control virtual media presentations 440 and control community interactions such as the type of interface or avatar that may be displayed for a respective user on a given day. For example, if a slide presentation were given, slide backgrounds or sounds can automatically be adjusted as scenes change to reflect a given mood. In a macro sense, room conditions could be altered as the presentations were given in order to adjust to conditions provided by the respective presentation. For example, if a disaster scene were displayed, somber music could be lightly played in the background, whereas if a joyous announcement were made, upbeat music played loudly might be employed. At 450, a mood sensing ring or other type of jewelry can be employed to indicate mood. This may include jewelry that is equipped with micro components for sensing one's mood and adjusting outputs from the jewelry. For example, if a locket were to monitor breathing and heart rate to detect mode and altering a light display from the locket based on the detected mood. As can be appreciated, substantially any type of application that monitors some activity of a user and automatically adjust data or an interface in view of the detected activity can be employed.

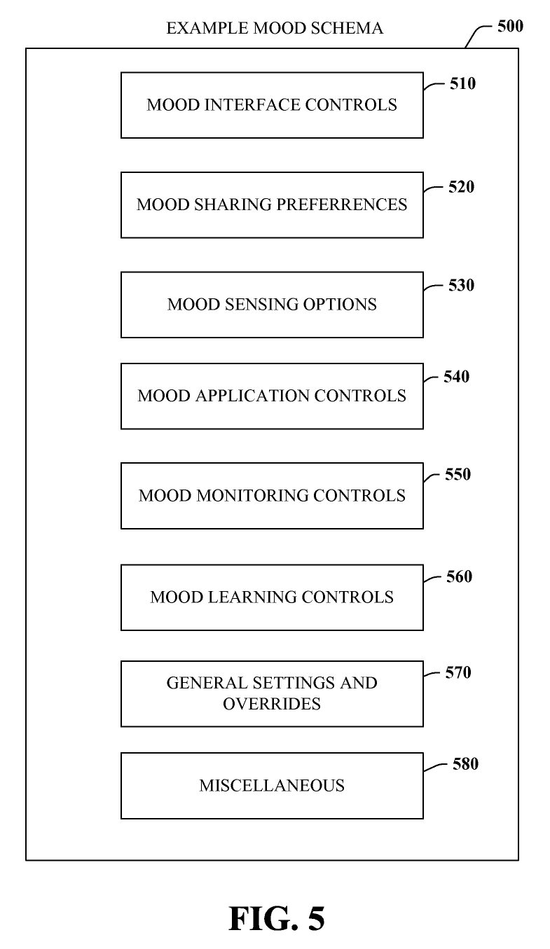

Proceeding to FIG. 5, an example mood schema 500 is illustrated. The mood schema 500 can be employed by applications to determine a user's preferences on how detected mood data is to be processed and subsequently employed with various applications. One or more mood interface controls 510 can be described and adjusted via the schema 500. The mood interface controls 500 allow the user to select desired interfaces base on detected moods, define which moods should trigger an interface change, limit the range of detected moods, adjust thresholds for detected moods and so forth. Substantially any type of adjustment to alter mood decision-making can be provided. These can include parameters, selections, rules and policies, for example. One or more mood sharing preferences 530 indicate how a user wants to share mood data with other users or groups. For example, during work hours, a user may not want to share any type of mood information with an application whereas during other times, the user may want to share a subset of determined or selected emotions.

Another type of schema value includes mood sensing options 530. This can include enabling or disabling various mood sensors or algorithms, editing mood dynamics such as the type of icon to display when a certain mood is detected, and what type of output can be altered when one or more changes are determined. Mood application controls 540 allow adjusting which applications are affected by mood data and how to apply such data to the respective application. For example, a user may specify they want mood data attached to all e-mails sent home yet prohibit mood data from being sent to customers. Mood monitoring controls 550 provide adjustments for background monitoring and learning that may be employed during mode detection and capture operations. For example, a user's cell phone can be configured to ring loudly when the user is detected in one type of mood or to ring softly in the user is detected in yet another mood.

Mood learning controls 560 enable users to adjust and configure learning components such as classifiers that may be employed to detect mood changes. For example, users can specify when they are in a given state of mind in order for the learning components to acquire context regarding the specified state. Such controls 560 can also be used to configure learning options such as when training periods begin and end and what type of learning components are employed (e.g., Support Vector Machines, Hidden Markov Models). One or more general settings and overrides 570 can be employed. These settings 570 are global in nature and can impact the previous settings and controls described. For instance a general setting 570 could specify that at certain times of the day, mood detection is to be enabled or disabled respectively. In another example, cultural or regional templates can be provided. For example, a southern climate would result in a higher temp profile than a northern climate such as Iceland. Also, some cultures might have mood nuances, where certain expressions have different meanings (e.g., sticking one's tongue out in Nepal is how one says hello). One or more miscellaneous controls allow for specific system adjustments such as to indicate audio levels when certain moods are detected and to indicate which applications such audio may be employed, for example.

Before proceeding, it is noted that the schema 500 can be supported in several languages. Generally, a schema is a model for describing the structure of information. It's a term borrowed from database components to describe the structure of data in relational tables. In the context of XML for example, the schema describes a model for a class of documents and data files. The model describes the possible arrangement of tags and text in a valid document, for example. The schema 500 can also be viewed as an agreement on a common vocabulary for a particular application that involves exchanging documents. In schemas, models are generally described in terms of constraints. A constraint defines what can appear in any given context. There are basically two types of constraints: content model constraints describe the order and sequence of elements and data type constraints describe valid units of data. For example, a schema might describe a valid <address> with the content model constraint that it consists of a <name> element, followed by one or more <street> elements, followed by one <city>, <state>, and <zip> element. The content of a <zip> might have a further data type constraint that it consist of either a sequence of exactly five digits or a sequence of five digits, followed by a hyphen, followed by a sequence of four digits, for example. One application of the schema 500 is to allow machine validation of document structure. Thus, an individual document which doesn't violate any of the constraints of the model is, by definition, valid according to that schema.

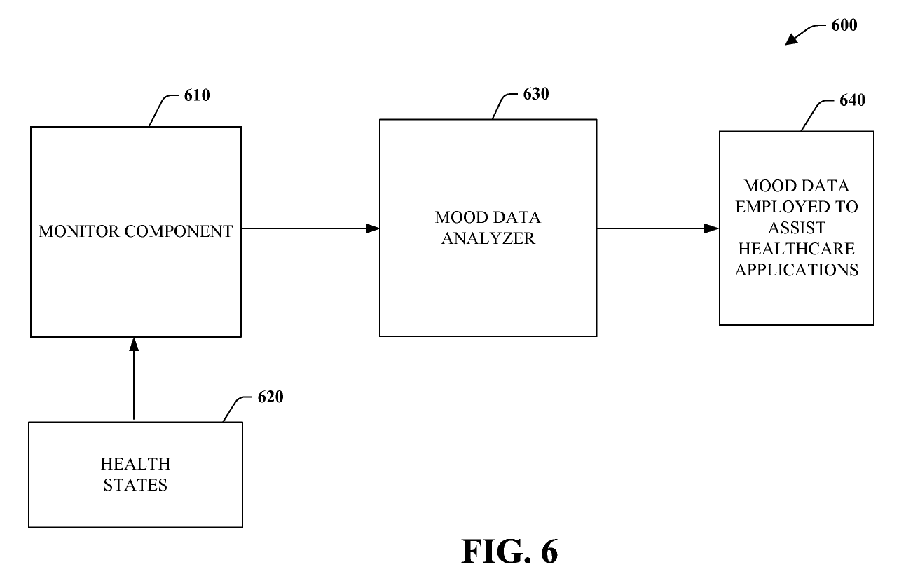

Referring to FIG. 6, a system 600 illustrates healthcare applications that can be facilitated by mood detection. The system 600 includes monitor component 610 that receives health states 620 from a user. For example, this could include a gaze monitor 610 that monitors activity or health states during a game or a keyboard monitor that monitors how keystrokes are entered over time. A mood data analyzer 630 receives data form the monitor 610 and processes the data to detect physical changes over time. For example, the analyzer 630 may determine that a user's response time to a given game as gradually declined over time. Such detection may be in terms of fractions of a second that could indicate the onset of a potential health problem. Thus, mood data captured during gaming or other applications can be analyzed by health care components or professionals at 640 to detect potential declines in user ability.

As noted previously, interactive data can be generated from the monitor component 610 in view of the mood data and can be employed to help such problems as attention deficits and other ailments. Special needs people can more affectively communicate when there emotions are also considered along with their explicit communications. Applications can be constructed to account for such needs. For example, if autism were potentially a problem then small changes in expression may be captured to indicate potentially greater mood changes. Parental controls can be employed with mood data to facilitate rearing of children. This includes include enabling adaptive components that can be adjusted on detected emotions, learning problems that are assisted by mood generated data, and monitoring a loved one who for one reason or another is incapable of communicating as in the past. This can include game monitoring at 610 and possibly detecting health issues such as Alzheimer's disease based on monitoring game responses over time. Games can also have their options or outcomes changed based on detected emotions along with having environmental changes affected by the respective emotions. In another example, game applications can have their outcomes adjusted based on detected emotions or user health states 620.

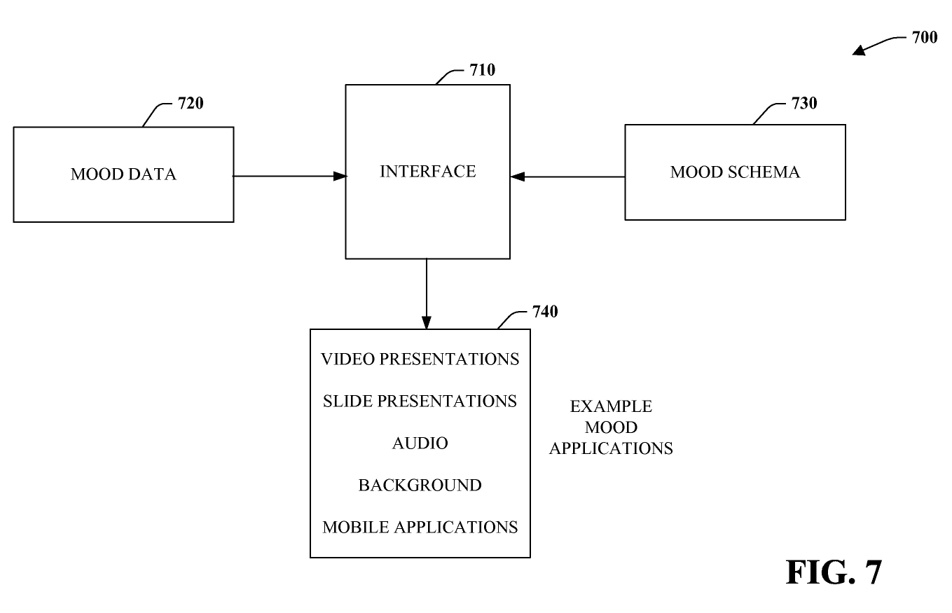

Referring to FIG. 7, a system 700 illustrates an adaptable mood interface 710 that is employed to control various applications. The mood interface 710 receives real time mood data 720 such as from biometric devices described above. The interface 710 can be adapted with processors and algorithms to analyze the mood data and determine a given mood or user state. A mood schema 730 can also be processed to control how mood algorithms are processed and applied. At 740, one or mood applications are controlled by the interface 710. As shown in one example, the applications 740 can include video presentations. Thus, if the mood of a user or a group were detected to change during a given presentations, conditions for the display such as sounds, lighting, and color could be dynamically adjusted for example. Another type of application 740 includes slide presentations where a series of slides are displayed in some manner. Still yet other types of applications 740 include an type of audio presentations or outputs such as cell phone interfaces, computer presentations, auditorium presentations, or live broadcasts (e.g., when the detected emotion of a crowd changes, alter background sound levels). Other applications 740 include background applications which involve substantially any type of computer output or display that is adjusted based off a detected mood change. Mobile applications can include changing conditions inside a car for example changing how a dashboard controls are presented, what type of music or how it is presented based off of detected moods.

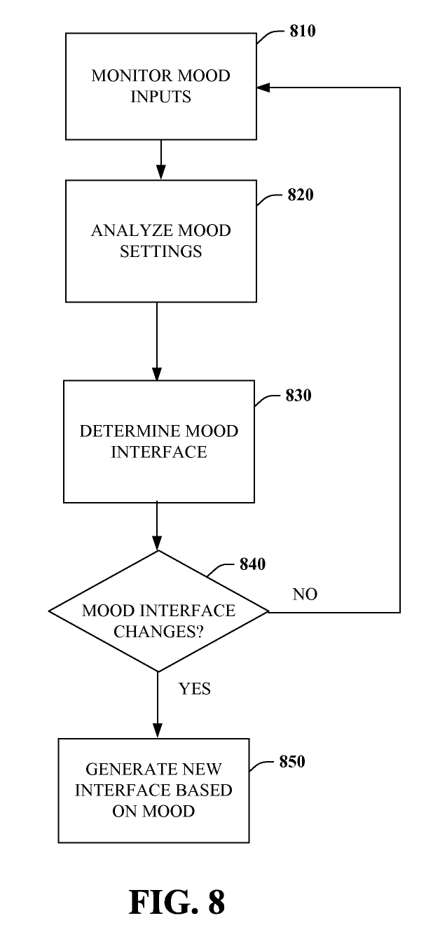

FIG. 8 illustrates an exemplary process 800 for analyzing mood data and controlling various applications from the mood data. While, for purposes of simplicity of explanation, the process is shown and described as a series or number of acts, it is to be understood and appreciated that the subject processes are not limited by the order of acts, as some acts may, in accordance with the subject processes, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject processes described herein.

Proceeding to 810, one or more mood inputs are processed. These can include substantially any type of input that can be detected from human activity such as biometric sensing or computer monitoring, for example. At 820, mood settings are analyzed. These can include mood controls and preferences of a user on how and when detected mood data is to be applied to a given application. Such preferences may be specified in a schema for example. At 830, an interface is selected based of the mood inputs from 810 and the settings 820. This can include altering inputs or outputs from the interface to coincide adjust to a determined mood. At 840, a background process is employed to determine whether or not a mood has changed from a previous setting. If no such change is detected at 840, the process proceeds back to 810 and processes mood inputs. If a mood change is detected at 840, a new interface is generated at 850. For example, a previous interface may have display a bold border on the outlines of a presentation during an emotional portion of the presentation. If a mood change has been detected for a mellow mood during the presentation, the border could change to reflect the mood. As can be appreciated, substantially any type of output for a presentation could be adjusted based upon a detected mood change.

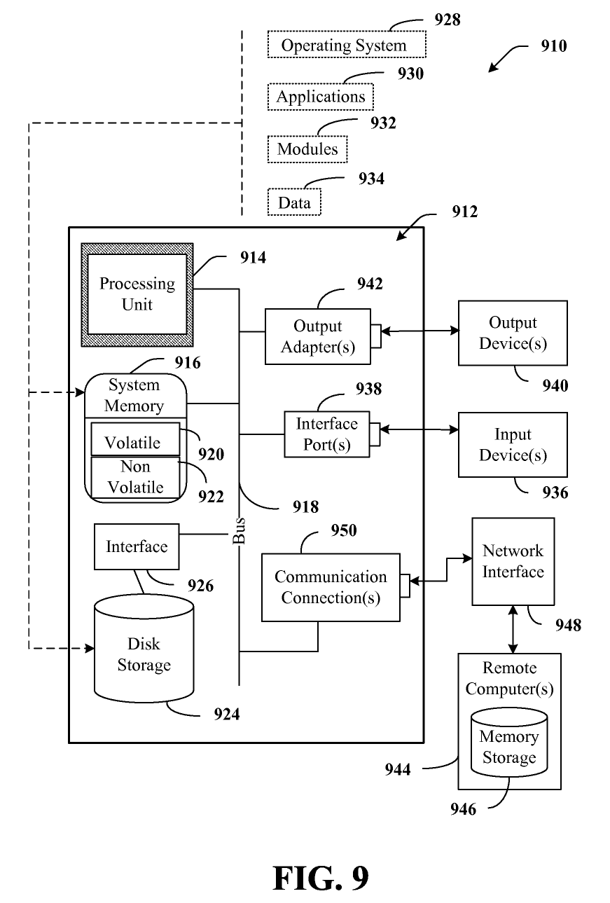

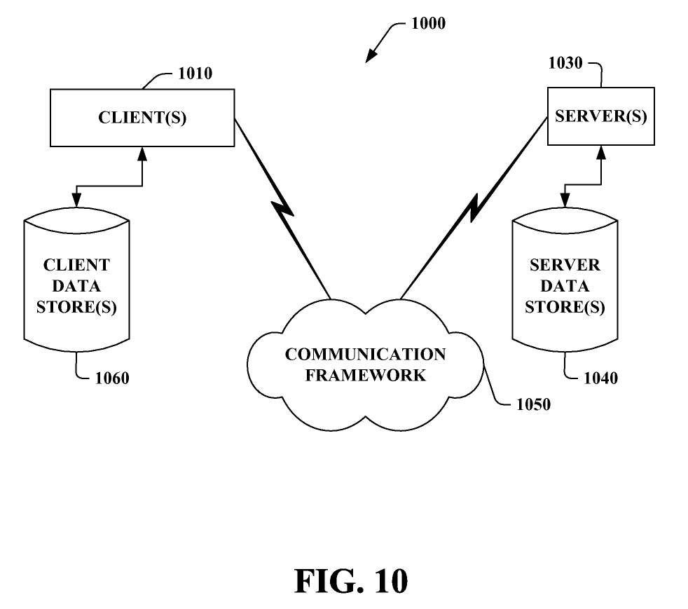

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that performs particular tasks and/or implements particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 9, an exemplary environment 910 for implementing various aspects described herein includes a computer 912. The computer 912 includes a processing unit 914, a system memory 916, and a system bus 918. The system bus 918 couple system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 64-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates, for example a disk storage 924. Disk storage 924 includes, but is not limited to, devices like a magnetic disk drive, floppy disk drive, tape drive, Jazz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912 and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operably connected to one or more client data store(s) 1060 that can be employed to store information local to the client(s) 1010. Similarly, the server(s) 1030 are operably connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates personalized sensing, comprising:
a sensing component that determines one or more user states based in part on a detected context; and
a mood component that employs the determined user states to indicate a dynamic condition of a user.

2. The system of claim 1, further comprising a local or remote data store to maintain the user states.

3. The system of claim 1, further comprising a user component that includes files or data structures that maintain states about the user and is employed to determine future states.

4. The system of claim 1, the mood component is employed to dynamically adjust a user interface.

5. The system of claim 1, the sensing component is associated with an audio sensor, a facial recognition sensor, a biometric sensor, a background monitor, a classifier, or a device sensor.

6. The system of claim 1, the mood component is associated with a schema to affect operations and control of a user interface.

7. The system of claim 6, the schema includes a mood interface control, a mood sharing preference, a mood sensing option, a mood application control, a mood monitoring control, a mood learning control, or a general control.

8. The system of claim 1, the sensing component is employed to determine user or group context.

9. The system 1, the mood component is associated with a personal item worn by a user.

10. The system of claim 1, the mood component is employed to control one or more mood applications.

11. The system of claim 10, the mood applications include a mood metadata attachment that is automatically applied to an application.

12. The system of claim 10, the mood applications are associated with interpersonal data sharing, context data sharing, or virtual media presentations.

13. The system of claim 1, the mood component is associated with a gaming application.

14. The system of claim 13, the gaming application is monitored to detect a potential health issue.

15. The system of claim 14, further comprising one or more game options that are altered based upon detected moods.

16. A method to automatically adjust an interface, comprising:
monitoring human activities to determine a user state;
analyzing the user state to determine an interface adjustment; and
applying the interface adjustment to an application to coincide with the user state.

17. The method of claim 16, further comprising analyzing a background activity or a biometric sensor to determine the user state.

18. The method of claim 16, further comprising monitoring a game application to determine a health problem for a user.

19. The method of claim 18, further comprising generating a schema to control mood interface options and preferences.

20. An adaptable interface system, comprising:
means for detecting one or more mood states of a user or group;
means for analyzing the mood states of the user or group; and
means for controlling the mood states with respect to a selected application.
